(19) United States
(12) Patent Application Publication
(10) Pub. No.: US 2008/0167418 A1
(43) Pub. Date: Jul. 10, 2008

(54) Method for Producing an Aqueous Polyamide Dispersion

(75) Inventors: Xiang-Ming Kong, Mainz (DE); Motonori Yamamoto, Mannheim (DE); Dietmar Haring, Schriesheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/720,436

(22) PCT Filed: Nov. 29, 2005
(86) PCT No.: PCT/EP05/12731

§ 371 Date: May 30, 2007

(30) Foreign Application Priority Data
Dec. 1, 2004 (DE) 10 2004 058 073.1

(51) Int. Cl. C08G 69/14; C08L 77/02

(52) U.S. Cl. 524/498; 528/312

(57) ABSTRACT

A process for preparing an aqueous polyamide dispersion by hydrolase-catalyzed reaction of an aminocarboxylic acid compound in aqueous medium.

The present invention provides a process for preparing an aqueous polyamide dispersion, which comprises reacting, in an aqueous medium,

a) an aminocarboxylic acid compound A

in the presence

b) of a hydrolase B and

c) of a dispersant C, and

d) if appropriate of a low water solubility organic solvent D.

Aqueous polyamide dispersions are used widely, for example, for producing hotmelt adhesives, coating formulations, printing inks, papercoating slips, etc.

Processes for preparing aqueous polyamide dispersions are common knowledge. The preparation is generally effected in such a way that an organic aminocarboxylic acid compound is converted to a polyamide compound. This polyamide compound is then generally first to a polyamide melt in a subsequent stage and the melt is then dispersed in an aqueous medium to form what is known as a secondary dispersion with the aid of organic solvents and/or dispersants by various methods. When a solvent is used, it has to be distilled off again after the dispersion step (on this subject, see, for example, DE-B 1028328, U.S. Pat. No. 2,951,054, U.S. Pat. No. 3,130,181, U.S. Pat. No. 4,886,844, U.S. Pat. No. 5,236,996, U.S. Pat. No. 6,777,488, WO 97/47686 or WO 98/44062).

The known processes for preparing aqueous polyamide dispersions are generally multistage, technically very complex and energetically very demanding. Especially when high molecular weight polyamide and organic solvents are used, the polyamide solutions obtained therefrom are extremely viscous and therefore difficult to handle and difficult to disperse in aqueous medium.

It is an object of the present invention to provide a novel process for preparing aqueous polyamide dispersions, which affords the aqueous polyamide dispersions in aqueous medium directly from an aminocarboxylic acid compound, without an additional dispersion/distillation stage, in good yields.

Surprisingly, the object is achieved by the process defined at the outset.

Useful aminocarboxylic acid compounds A are any organic compounds which have an amino and a carboxyl group in free or derivatized form, but in particular the C₂-C₃₀-aminocarboxylic acids, the C₁-C₅-alkyl esters of the aforementioned aminocarboxylic acids, the corresponding C₃-C₁₅-lactam compounds, the C₂-C₃₀-aminocarboxamides or the C₂-C₃₀-aminocarbonitriles. Examples of the free C₂-C₃₀-aminocarboxylic acids include the naturally occurring aminocarboxylic acids such as valine, leucine, isoleucine, threonine, methionine, phenylalanine, tryptophan, lysine, alanine, arginine, aspartic acid, cysteine, glutamic acid, glycine, histidine, proline, serine, tyrosine, asparagine or glutamine, and also 3-aminopropionic acid, 4-aminobutyric acid, 5-aminovaleric acid, 6-aminocaproic acid, 7-aminoenanthic acid, 8-aminocaprylic acid, 9-aminopelargonic acid, 10-aminocapric acid, 11-aminoundecanoic acid, 12-aminolauric acid, 13-aminotridecanoic acid, 14-aminotetradecanoic acid or 15-aminopentadecanoic acid. Examples of the C₁-C₅-alkyl esters of the aforementioned aminocarboxylic acids include methyl and ethyl 3-aminopropionate, methyl and ethyl 4-aminobutyrate, methyl and ethyl 5-aminovalerate, methyl and ethyl 6-aminocaproate, methyl and ethyl 7-aminoenanthate, methyl and ethyl 8-aminocaprylate, methyl and ethyl 9-aminopelargonate, methyl and ethyl 10-aminocaprate, methyl and ethyl 11-aminoundecanoate, methyl and ethyl 12-aminolaurate, methyl and ethyl 13-aminotridecanoate, methyl and ethyl 14-aminotetradecanoate or methyl and ethyl 15-aminopentadecanoate. Examples of the C₃-C₁₅-lactam compounds include β-propiolactam, γ-butyrolactam, δ-valerolactam, ε-caprolactam, 7-enantholactam, 8-caprylolactam, 9-pelargolactam, 10-caprinolactam, 11-undecanolactam, ω-laurolactam, 13-tridecanolactam, 14-tetradecanolactam or 15-pentadecanolactam. Examples of the aminocarboxamides include 3-aminopropionamide, 4-aminobutyramide, 5-aminovaleramide, 6-aminocapronamide, 7-aminoenanthamide, 8-aminocaprylamide, 9-aminopelargonamide, 10-aminocaprinamide, 11-aminoundecanamide, 12-aminolauramide, 13-aminotridecanamide, 14-aminotetradecanamide or 15-aminopentadecanamide, and examples of the aminocarbonitriles include 3-aminopropionitrile, 4-aminobutyronitrile, 5-aminovaleronitrile, 6-aminocapronitrile, 7-aminoenanthonitrile, 8-aminocaprylonitrile, 9-aminopelargonitrile, 10-aminocaprinonitrile, 11-aminoundecanonitrile, 12-aminolauronitrile, 13-aminotridecanonitrile, 14-aminotetradecanonitrile or 15-aminopentadecanonitrile. However, preference is given to the C₃-C₁₅-lactam compounds and among these in particular to ε-caprolactam and to ω-laurolactam. Particular preference is given to ε-caprolactam. It will be appreciated that mixtures of the aforementioned aminocarboxylic acid compounds A may also be used.

It is essential to the process that the reaction of the aminocarboxylic acid compound A in aqueous medium proceeds in the presence of a hydrolase B. The hydrolases B are an enzyme class familiar to those skilled in the art. Depending on the type of the aminocarboxylic acid compound A used, the hydrolase B is selected so as to be capable of catalyzing a polycondensation reaction of the amino groups and of the carboxyl groups in free or derivatized form, for example with elimination of water (free aminocarboxylic acids), alcohol (esters of aminocarboxylic acids) or hydrogen halide (halides of aminocarboxylic acids) and/or a ring-opening with subsequent polyaddition, for example in the case of the aforementioned C₃-C₁₅-lactam compounds.

Especially suitable as hydrolases B [EC 3.x.x.x] are, for example, esterases [EC 3.1.x.x], proteases [EC 3.4.x.x] and/or hydrolases which react with C—N bonds other than peptide bonds. Advantageously in accordance with the invention, carboxylesterases [EC 3.1.1.1] and/or lipases [EC 3.1.1.3] in particular are used. Examples thereof are lipases from Achromobacter sp., Aspergillus sp., Candida sp., Candida antarctica, Mucor sp., Penicilium sp., Geotricum sp., Rhizopus sp, Burkholderia sp., Pseudomonas sp., Pseudomonas cepacia, Thermomyces sp., porcine pancreas or wheat-germs, and carboxylesterases from Bacillus sp., Pseudomonas sp., Burkholderia sp., Mucor sp., Saccharomyces sp., Rhizopus sp., Thermoanaerobium sp., porcine liver or equine liver. It will be appreciated that it is possible to use a single hydrolase B or a mixture of different hydrolases B. It is also possible to use the hydrolases B in free and/or immobilized form.

Preference is given to using lipase from Pseudomonas cepacia, Burkholderia platarii or Candida antarctica in free and/or immobilized form (for example Novozym® 435 from Novozymes A/S, Denmark).

The total amount of hydrolases B used is generally from 0.001 to 40% by weight, frequently from 0.1 to 15% by weight and often from 0.5 to 8% by weight, based in each case on the total amount of aminocarboxylic acid compound A.

The dispersants C used in the process according to the invention may in principle be emulsifiers and/or protective colloids. It is self-evident that the emulsifiers and/or protective colloids are selected so as to be compatible especially with the hydrolases B used and not to deactivate them. Which emulsifiers and/or protective colloids can be used for a certain hydrolase B is known to or can be determined by those skilled in the art in simple preliminary experiments.

Suitable protective colloids are, for example, polyvinyl alcohols, polyalkylene glycols, alkali metal salts of polyacrylic acids and polymethacrylic acids, gelatin derivatives or copolymers containing acrylic acid, methacrylic acid, maleic anhydride, 2-acrylamido-2-methylpropanesulfonic acid and/or 4-styrenesulfonic acid, and alkali metal salts thereof, but also homo- and copolymers containing N-vinylpyrrolidone, N-vinylcaprolactam, N-vinylcarbazole, 1-vinylimidazole, 2-vinylimidazole, 2-vinylpyridine, 4-vinylpyridine, acrylarnide, methacrylamide, amine-bearing acrylates, methacrylates, acrylamides and/or methacrylamides. A comprehensive description of further suitable protective colloids can be found in Houben-Weyl, Methoden der organischen Chemie [Methods of Organic Chemistry], volume XIV/1, Makromolekulare Stoffe [Macromolecular substances], Georg-Thieme-Verlag, Stuttgart, 1961, p. 411 to 420.

It will be appreciated that mixtures of protective colloids and/or emulsifiers may also be used. Frequently, the dispersants used are exclusively emulsifiers whose relative molecular weights, in contrast to the protective colloids, are typically below 1000. They may be of anionic, cationic or nonionic nature. In the case of the use of mixtures of interface-active substances, it will be appreciated that the individual components have to be compatible with one another, which can be checked in the case of doubt by a few preliminary experiments. In general, anionic emulsifiers are compatible with one another and with nonionic emulsifiers. The same also applies to cationic emulsifiers, while anionic and cationic emulsifiers are usually not compatible with one another. An overview of suitable emulsifiers can be found in Houben-Weyl, Methoden der organischen Chemie, volume XIV/1, Makromolekulare Stoffe [Macromolecular substances], Georg-Thieme-Verlag, Stuttgart, 1961, p 192 to 208.

However, the dispersants C used in accordance with the invention are in particular emulsifiers.

Nonionic emulsifiers which can be used are, for example, ethoxylated monoalkylphenols, dialkylphenols and trialkylphenols (EO units: 3 to 50, alkyl radical: C₄ to C₁₂) and ethoxylated fatty alcohols (EO units: 3 to 80; alkyl radical: C₈ to C₃₆). Examples of such emulsifiers are the Lutensol® A brands (C₁₂C₁₄ fatty alcohol ethoxylates, EO units: 3 to 8), Lutensol® AO brands (C₁₃C₁₅ oxo alcohol ethoxylates, EO units: 3 to 30), Lutensol® AT brands (C₁₆C₁₈ fatty alcohol ethoxylates, EO units: 11 to 80), Lutensol® ON brands (C₁₀ oxo alcohol ethoxylates, EO units: 3 to 11) and the Lutensol® TO brands (C₁₃ oxo alcohol ethoxylates, EO units: 3 to 20) from BASF AG.

Customary anionic emulsifiers are, for example, alkali metal and ammonium salts of alkyl sulfates (alkyl radical: C₈ to C₁₂), of sulfuric monoesters of ethoxylated alkanols (EO units: 4 to 30, alkyl radical: C₁₂ to C₁₈) and ethoxylated alkylphenols (EO units: 3 to 50, alkyl radical: C₄ to C₁₂), of alkylsulfonic acids (alkyl radical: C₁₂ to C₁₈) and of alkylarylsulfonic acids (alkyl radical: C₉ to C₁₈).

Further anionic emulsifiers which have been found to be useful are compounds of the general formula (I)

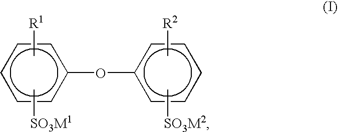

where R¹ and R² are each hydrogen atoms or C₄- to C₂₄-alkyl and are not both hydrogen atoms, and M¹ and M² may be alkali metal ions and/or ammonium ions. In the general formula (I), R¹ and R² are preferably linear or branched alkyl radicals having from 6 to 18 carbon atoms, in particular having 6, 12 or 16 carbon atoms, or hydrogen, but R¹ and R² are not both hydrogen atoms. M¹ and M² are preferably sodium, potassium or ammonium, of which sodium is particularly preferred. Particularly advantageous compounds (I) are those in which M¹ and M² are each sodium, R¹ is a branched alkyl radical having 12 carbon atoms and R² is a hydrogen atom or R¹. Frequently, technical-grade mixtures which have a proportion of from 50 to 90% by weight of the monoalkylated product are used, for example Dowfax® 2A1 (brand of Dow Chemical Company). The compounds (I) are common knowledge, for example from U.S. Pat. No. 4,269,749, and are commercially available.

Suitable cation-active emulsifiers are generally primary, secondary, tertiary or quaternary ammonium salts having a C₆- to C₁₈-alkyl, C₆- to C₁₈-alkylaryl or heterocyclic radical, alkanolammonium salts, pyridinium salts, imidazolinium salts, oxazolinium salts, orpholinium salts, thiazolinium salts and salts of amine oxides, quinolinium salts, isoquinolinium salts, tropylium salts, sulfonium salts and phosphonium salts. Examples include dodecylammonium acetate or the corresponding sulfate, the sulfates or acetates of the various 2-(N,N,N-trimethylammonium)ethylparaffinic esters, N-cetylpyridinium sulfate, N-laurylpyridinium sulfate and N-cetyl-N,N,N-trimethylammonium sulfate, N-dodecyl-N,N,N-trimethylammonium sulfate, N-octyl-N,N,N-trimethylammonium sulfate, N,N-distearyl-N,N-dimethylammonium sulfate and also the Gemini surfactant N,N′-(lauryidimethyl)ethylenediamine disulfate, ethoxylated tallow fat alkyl-N-methylammonium sulfate and ethoxylated oleylamine (for example Uniperol® AC from BASF AG, approx. 12 ethylene oxide units). Numerous further examples can be found in H. Stache, Tensid-Taschenbuch [Surfactants Handbook], Carl-Hanser-Verlag, Munich, Vienna, 1981, and in McCutcheon's, Emulsifiers & Detergents, MC Publishing Company, Glen Rock, 1989. It is important that the anionic counter-groups have a very low nucleophilicity, for example perchlorate, sulfate, phosphate, nitrate and carboxylates, for example acetate, trifluoroacetate, trichloroacetate, propionate, oxalate, citrate, benzoate, and also conjugate anions of organic sulfonic acids, for example methylsulfonate, trifluoromethylsulfonate and para-toluenesulfonate, and also tetrafluoroborate, tetraphenylborate, tetrakis(pentafluorophenyl)borate, tetrakis[bis(3,5-trifluoromethyl)phenyl]borate, hexafluorophosphate, hexafluoroarsenate or hexafluoroantimonate.

The emulsifiers which are used with preference as dispersants C are advantageously used in a total amount of from 0.005 to 20% by weight, preferably from 0.01 to 15% by weight, in particular from 0.1 to 10% by weight, based in each case on the total amount of aminocarboxylic acid compound A.

The total amount of the protective colloids used as dispersants C in addition to or instead of the emulsifiers is often from 0.1 to 10% by weight and frequently from 0.2 to 7% by weight, based in each case on the total amount of aminocarboxylic acid compound A.

However, preference is given to using nonionic emulsifiers as the sole dispersant C.

According to the invention, low water solubility organic solvents D may also optionally be used. Suitable solvents D are liquid aliphatic and aromatic hydrocarbons having from 5 to 30 carbon atoms, for example n-pentane and isomers, cyclopentane, n-hexane and isomers, cyclohexane, n-heptane and isomers, n-octane and isomers, n-nonane and isomers, n-decane and isomers, n-dodecane and isomers, n-tetradecane and isomers, n-hexadecane and isomers, n-octadecane and isomers, benzene, toluene, ethylbenzene, cumene, o-, m- or p-xylene, mesitylene, and generally hydrocarbon mixtures in the boiling range of from 30 to 250° C. It is likewise possible to use hydroxyl compounds such as saturated and unsaturated fatty alcohols having from 10 to 28 carbon atoms, for example n-dodecanol, n-tetradecanol, n-hexadecanol and isomers thereof, or cetyl alcohol, esters, for example fatty acid esters having from 10 to 28 carbon atoms in the acid moiety and from 1 to 10 carbon atoms in the alcohol moiety, or esters of carboxylic acids and fatty alcohols having from 1 to 10 carbon atoms in the carboxylic acid moiety and from 10 to 28 carbon atoms in the alcohol moiety. It will be appreciated that it is also possible to use mixtures of the aforementioned solvents D.

The total amount of any solvent D used is up to 60% by weight, preferably from 0.1 to 40% by weight and especially preferably from 0.5 to 10% by weight, based in each case on the total amount of water used.

It is advantageous when the solvent D and its amount are selected in such a way that the solubility of the solvent D in the aqueous medium under reaction conditions is≦50% by weight, ≦40% by weight, ≦30% by weight, ≦20% by weight or ≦10% by weight, based in each case on the total amount of solvent, and is thus present as a separate phase in the aqueous medium.

Solvents D are used especially when the aminocarboxylic acid compound A has a good solubility in the aqueous medium under reaction conditions, i.e. its solubility is≧10 g/l, ≧30 g/l or frequently≧50 g/l or≧100 g/l.

The process according to the invention proceeds advantageously when at least one portion of the aminocarboxylic acid compound A and/or if appropriate of the solvent D is present in the aqueous medium as a disperse phase having an average droplet diameter of ≦1000 nm (what is known as an oil-in-water miniemulsion or a miniemulsion for short).

With particular advantage, the process according to the invention proceeds in such a way that at least a portion of aminocarboxylic acid compound A, dispersant C and if appropriate solvent D is first introduced into a portion or even the entirety of the water, then a disperse phase which comprises the aminocarboxylic acid compound A and/or if appropriate the solvent D and has an average droplet diameter of ≦1000 nm (miniemulsion) is obtained by means of suitable measures, and then the entirety of the hydrolase B and any remaining amounts of water, aminocarboxylic acid compound A, dispersant C and if appropriate solvent D are added at reaction temperature to the aqueous medium. Frequently, ≧50% by weight, ≧60% by weight, ≧70% by weight, ≧80% by weight, ≧90% by weight or even the entireties of aminocarboxylic acid compound A, dispersant C and if appropriate solvent D are introduced into ≧50% by weight, ≧60% by weight, ≧70% by weight, ≧80% by weight, ≧90% by weight or even the entirety of the water, then the disperse phase having an average droplet diameter of ≦1000 nm is obtained, and then the entirety of the hydrolase B and any remaining amounts of water, aminocarboxylic acid compound A, dispersant C and if appropriate solvent D are added at reaction temperature to the aqueous medium. The hydrolase B and any remaining amounts of water, aminocarboxylic acid compound A, dispersant C and if appropriate solvent D may be added to the aqueous reaction medium discontinuously in one portion, discontinuously in several portions or continuously with uniform or varying mass flow rates.

Frequently, the entireties of aminocarboxylic acid compound A and if appropriate solvent D, and also at least a portion of the dispersant C, are introduced into the majority or entirety of the water and, after the miniemulsion has formed, the entirety of the hydrolase B, if appropriate together with the remaining amounts of the water and of the dispersant C, are added at reaction temperature to the aqueous reaction medium.

The average size of the droplets of the disperse phase of the aqueous miniemulsion to be used advantageously in accordance with the invention can be determined by the principle of quasielastic dynamic light scattering (what is known as the z-average droplet diameter d_{z} of the unimodal analysis of the autocorrelation function). In the examples of this document, a Coulter N4 Plus Particle Analyzer from Coulter Scientific Instruments was used for this purpose (1 bar, 25° C.). The measurements were undertaken on diluted aqueous miniemulsions whose content of nonaqueous constituents was 0.01% by weight. The dilution was undertaken by means of water which had been saturated beforehand with the aminocarboxylic acid compound A present in the aqueous miniemulsion and/or the low water solubility organic solvent D. The latter measure is intended to prevent the dilution from being accompanied by a change in the droplet diameter.

According to the invention, the values of d_{z} determined in this way for the miniemulsions are normally ≦700 nm, frequently ≦500 nm. According to the invention, the d_{z} range of from 100 nm to 400 nm or of from 100 nm to 300 nm is favorable. Normally, d_{z} of the aqueous miniemulsion to be used in accordance with the invention is ≧40 nm.

The general preparation of aqueous miniemulsions from aqueous macroemulsions is known to those skilled in the art (cf. P. L. Tang, E. D. Sudol, C. A. Silebi and M. S. El-Aasser in Journal of Applied Polymer Science, Vol. 43, p. 1059 to 1066 [1991]).

For this purpose, high-pressure homogenizers, for example, may be employed. The fine dispersion of the components is achieved in these machines by a high localized energy input. Two variants have been found to be particularly useful for this purpose.

In the first variant, the aqueous macroemulsion is pressurized to above 1000 bar by means of a piston pump and is subsequently depressurized through a narrow slit. The action is based here on an interaction of high shear and pressure gradients and cavitation in the slit. An example of a high-pressure homogenizer which functions according to this principle is the Niro-Soavi high-pressure homogenizer model NS1001L Panda.

In the second variant, the pressurized aqueous macroemulsion is depressurized into a mixing chamber through two nozzles pointing toward one another. The fine-dispersing action is dependent here in particular on the hydrodynamic conditions in the mixing chamber. An example of a homogenizer of this type is the Microfluidizer model M 120 E from Microfluidics Corp. In this high-pressure homogenizer, the aqueous macroemulsion is compressed to pressures of up to 1200 atm by means of a pneumatically driven piston pump and is depressurized via an “interaction chamber”. In the “interaction chamber”, the jet of emulsion is divided in a microchannel system into two jets which are directed at one another at an angle of 180°. A further example of a homogenizer operating by this homogenization principle is the Nanojet model Expo from Nanojet Engineering GmbH. However, in the Nanojet, two homogenization valves which can be mechanically adjusted are installed in place of a fixed channel system.

In addition to the principles described above, the homogenization can also be carried out, for example, by use of ultrasound (for example Branson Sonifier II 450). The fine dispersion is based here on cavitation mechanisms. For the homogenization by means of ultrasound, the apparatus described in GB-A 22 50 930 and U.S. Pat. No. 5,108,654 is in principle also suitable. The quality of the aqueous miniemulsion obtained in the sonic field depends not only on the acoustic power introduced but also on other factors, for example the intensity distribution of the ultrasound in the mixing chamber, the residence time, the temperature and the physical properties of the substances to be emulsified, for example on the viscosity, the surface tension and the vapor pressure. The resulting droplet size depends, inter alia, on the concentration of the emulsifier and on the energy introduced in the course of homogenization and can therefore be adjusted precisely by, for example, appropriate change in the homogenization pressure or the corresponding ultrasonic energy.

For the preparation of the aqueous miniemulsion used advantageously in accordance with the invention from conventional macroemulsions by means of ultrasound, the apparatus described in DE-A 197 56 874 has been found to be particularly useful. This is an apparatus which comprises a reaction chamber or a flow-through reaction channel and at least one means of transmitting ultrasound waves into the reaction chamber or the flow-through reaction channel, the means for transmitting ultrasound waves being configured in such a way that the entire reaction chamber, or a section of the flow-through reaction channel, can be irradiated uniformly with ultrasound waves. For this purpose, the emitting surface of the means for transmitting ultrasound waves is configured in such a way that it corresponds essentially to the surface of the reaction chamber or, if the reaction chamber is a section of a flow-through reaction channel, extends essentially over the entire width of the channel, and in such a way that the depth of the reaction chamber in a direction essentially perpendicular to the emitting surface is less than the maximum depth of action of the ultrasound transmission means.

Here, the term “depth of the reaction chamber” refers essentially to the distance between the emitting surface of the ultrasound transmission means and the bottom of the reaction chamber.

Preference is given to reaction chamber depths up to 100 mm. The depth of the reaction chamber should advantageously be not more than 70 mm and particularly advantageously not more than 50 mm. The reaction chambers can in principle also have a very small depth, but with a view to a very low risk of blockage and easy cleaning and also a high product throughput, preference is given to reaction chamber depths which are significantly greater than, for example, the customary slit widths in high-pressure homogenizers and are usually above 10 mm. The depth of the reaction chamber is advantageously adjustable, for example by virtue of ultrasound transmission means being immersible to different depths into the casing.

In a first embodiment of this apparatus, the emitting surface of the means for transmitting ultrasound corresponds essentially to the surface of the reaction chamber. This embodiment is employed for the batchwise preparation of the miniemulsions used in accordance with the invention. In this apparatus, ultrasound can act over the entire reaction chamber. Turbulent flow is generated in the reaction chamber by the axial acoustic radiative pressure and this effects intensive transverse mixing.

In a second embodiment, such an apparatus has a flow-through cell. The casing is configured as a flow-through reaction channel which has an inlet and an outlet, the reaction chamber being a section of the flow-through reaction channel. The width of the channel is the channel dimension running essentially perpendicular to the flow direction. Here, the emitting surface covers the entire width of the flow channel transverse to the flow direction. The length of the emitting surface perpendicular to this width, i.e. the length of the emitting surface in the flow direction, defines the region of action of the ultrasound. In an advantageous variant of this first embodiment, the flow-through reaction channel has an essentially rectangular cross section. When a likewise rectangular ultrasound transmission means having appropriate dimensions is installed in one side of the rectangle, particularly effective and uniform sonication is achieved. Owing to the turbulent flow conditions existing in the ultrasonic field, it is, however, also possible to use, for example, a round transmission means without disadvantages. Moreover, a plurality of separate transmission means can be arranged in succession in the flow direction in place of a single ultrasound transmission means. In this case, both the emitting surfaces and the depth of the reaction chamber, i.e. the distance between the emitting surface and the bottom of the flow-through channel, can vary.

The means for transmitting ultrasound waves is particularly advantageously configured as a sonotrode whose end opposite the free emitting surface is coupled to an ultrasonic transducer. The ultrasound waves can, for example, be generated by exploiting the reverse piezoelectric effect. In this case, high-frequency electric oscillations (typically in the range from 10 to 100 kHz, preferably from 20 to 40 kHz) are generated with the aid of generators, converted to mechanical vibrations of the same frequency by means of a piezoelectric transducer and radiated by means of the sonotrode as transmission element into the medium to be sonicated.

The sonotrode is more preferably configured as a rod-shaped, axially emitting λ/2 (or multiples of λ/2) longitudinal oscillator. Such a sonotrode may, for example, be secured in an orifice of the casing by means of a flange provided at one of its nodes of oscillation. This allows the passage of the sonotrode into the casing to be configured in a pressure-tight manner, so that the sonication can also be carried out under elevated pressure in the reaction chamber. The oscillation amplitude of the sonotrode is preferably controllable, i.e. the oscillation amplitude established in each case is checked online and, if appropriate, automatically adjusted under closed-loop control. The current oscillation amplitude can be checked, for example, by a piezoelectric transducer mounted on the sonotrode or a strain gauge with downstream evaluation electronics.

In a further advantageous design of such apparatus, internals are provided within the reaction chamber to improve the flow and mixing performance. These internals may be simple baffle plates or a wide variety of porous bodies.

If required, the mixing may also be intensified by an additional stirrer. Advantageously, the temperature of the reaction chamber can be controlled.

It becomes clear from the above remarks that it is possible in accordance with the invention only to use those organic solvents D or solvent mixtures whose solubility in the aqueous medium under reaction conditions is small enough to form solvent droplets of ≦1000 nm as a separate phase with the specified amounts. In addition, the dissolution capacity of the solvent droplets formed has to be large enough to take up at least portions, but preferably the entirety of the aminocarboxylic acid compound A.

It is important for the process according to the invention that, in addition to the aminocarboxylic acid compound A, it is possible to use a diamine compound E, a dicarboxylic acid compound F, a diol compound G, a hydroxycarboxylic acid compound H, an amino alcohol compound I and/or an organic compound K which contains at least 3 hydroxyl, primary or secondary amino and/or carboxyl groups per molecule. It is essential that the sum of the total amounts of individual compounds E, F, G, H, I and K is ≦100% by weight, preferably ≦80% by weight or ≦60% by weight and especially preferably ≦50% by weight or ≦40% by weight, and ≧0.1% by weight, frequently ≧1% by weight and often ≧5% by weight, based in each case on the total amount of aminocarboxylic acid compound A.

Useful diamine compounds E are any organic diamine compounds which have two primary or secondary amino groups, of which preference is given to primary amino groups. The organic basic skeleton having the two amino groups may have a C₂-C₂₀-aliphatic, C₃-C₂₀-cycloaliphatic, aromatic or heteroaromatic structure. Examples of compounds E having two primary amino groups are 1,2-diaminoethane, 1,3-diaminopropane, 1,2-diaminopropane, 2-methyl-1,3-diaminopropane, 2,2-dimethyl-1,3-25 diaminopropane (neopentyidiamine), 1,4-diaminobutane, 1,2-diaminobutane, 1,3-diaminobutane, 1-methyl-1,4-diaminobutane, 2-methyl-1,4-diaminobutane, 2,2-dimethyl-1,4-diaminobutane, 2,3-dimethyl-1,4-diaminobutane, 1,5-diaminopentane, 1,2-diaminopentane, 1,3-diaminopentane, 1,4-diaminopentane, 2-methyl-1,5-diaminopentane, 3-methyl-1,5-diaminopentane, 2,2-dimethyl-1,5-diaminopentane, 2,3-dimethyl-1,5-diaminopentane, 2,4-dimethyl-1,5-diaminopentane, 1,6-diaminohexane, 1,2-diaminohexane, 1,3-diaminohexane, 1,4-diaminohexane, 1,5-diaminohexane, 2-methyl-1,5-diaminohexane, 3-methyl-1,5-diaminohexane, 2,2-dimethyl-1,5-diaminohexane, 2,3-dimethyl-1,5-diaminohexane, 3,3-dimethyl-1,5-diaminohexane, N,N′-dimethyl-1,6-diaminohexane, 1,7-diaminoheptane 1,8-diaminooctane, 1,9-diaminononane, 1,10-diaminodecane, 1,11-diaminoundecane, 1,12-diaminododecane, 1,2-diaminocyclohexane, 1,3-diaminocyclohexane, 1,4-diaminocyclohexane, 3,3′-diaminodicyclohexylmethane, 4,4′-diaminodicyclohexylmethane (dicyan), 3,3′-dimethyl-4,4′-diaminodicyclohexylmethane (Laromin®), isophoronediamine (3-aminomethyl-3,5,5-trimethylcyclohexylamine), 1,4-diazine (piperazine), 1,2-diaminobenzene, 1,3-diaminobenzene, 1,4-diaminobenzene, m-xylyienediamine [1,3-(diaminomethyl)benzene] and p-xylylenediamine [1,4-(diaminomethyl)benzene]. It will be appreciated that it is also possible to use mixtures of the above compounds.

Preference is given to using 1,6-diaminohexane, 1,12-diaminododecane, 2,2-dimethyl-1,3-diaminopropane, 1,4-diaminocyclohexane, isophoronediamine, 3,3′-diaminodicyclohexylmethane, 4,4′-diaminodicyclohexylmethane, 3,3′-dimethyl-4,4′-diaminodicyclohexylmethane, m-xylylenediamine or p-xylylenediamine as optional diamine compounds E.

The dicarboxylic acid compounds F used may in principle be any C₂-C₄₀-aliphatic, C₃-C₂₀-cycloaliphatic, aromatic or heteroaromatic compounds which have two carboxylic acid groups (carboxyl groups; —COOH) or derivatives thereof. The derivatives which find use are in particular C₁-C₁₀-alkyl, preferably methyl, ethyl, n-propyl or isopropyl, mono- or diesters of the aforementioned dicarboxylic acids, the corresponding dicarbonyl halides, in particular the dicarbonyl chlorides and the corresponding dicarboxylic anhydrides. Examples of such compounds are ethanedioic acid (oxalic acid), propanedioic acid (malonic acid), butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), undecanedioic acid, dodecanedioic acid, tridecanedioic acid (brassylic acid), C₃₂-dimer fatty acid (commercial product from Cognis Corp., USA) benzene-1,2-dicarboxylic acid (phthalic acid), benzene-1,3-dicarboxylic acid (isophthalic acid) or benzene-1,4-dicarboxylic acid (terephthalic acid), the methyl esters thereof, for example dimethyl ethanedioate, dimethyl propanedioate, dimethyl butanedioate, dimethyl pentanedioate, dimethyl hexanedioate, dimethyl heptanedioate, dimethyl octanedioate, dimethyl nonanedioate, dimethyl decanedioate, dimethyl undecanedioate, dimethyl dodecanedioate, dimethyl tridecanedioate, C₃₂-dimer fatty acid dimethyl ester, dimethyl phthalate, dimethyl isophthalate or dimethyl terephthalate, the dichlorides thereof, for example ethanedioyl chloride, propanedioyl chloride, butanedioyl chloride, pentanedioyl chloride, hexanedioyl chloride, heptanedioyl chloride, octanedioyl chloride, nonanedioyl chloride, decanedioyl chloride, undecanedioyl chloride, dodecanedioyl chloride, tridecanedioyl chloride, C₃₂-dimer fatty acid chloride, phthaloyl chloride, isophthaloyl chloride or terephthaloyl chloride, and the anhydrides thereof, for example butanedicarboxylic anhydride, pentanedicarboxylic anhydride or phthalic anhydride. It will be appreciated that it is also possible to use mixtures of the above dicarboxylic acid compounds F.

Optionally and preferably, the free dicarboxylic acids, especially butanedioic acid, hexanedioic acid, decanedioic acid, dodecanedioic acid, terephthalic acid or isophthalic acid or the corresponding dimethyl esters thereof are used.

The optional diol compounds G which find use in accordance with the invention are branched or linear alkanediols having from 2 to 18 carbon atoms, preferably from 4 to 14 carbon atoms, cycloalkanediols having from 5 to 20 carbon atoms, or aromatic diols.

Examples of suitable alkanediols are ethylene glycol, 1,2-propanediol, 1,3-propanediol, 1,2-butanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 2,4-dimethyl-2-ethyl-1,3-hexanediol, 2,2-dimethyl-1,3-propanediol (neopentyl glycol), 2-ethyl-2-butyl-1,3-propanediol, 2-ethyl-2-isobutyl-1,3-propanediol or 2,2,4-trimethyl-1,6-hexanediol. Especially suitable are ethylene glycol, 1,3-propanediol, 1,4-butanediol and 2,2-dimethyl-1,3-propanediol, 1,6-hexanediol or 1,12-dodecanediol.

Examples of cycloalkanediols are 1,2-cyclopentanediol, 1,3-cyclopentanediol, 1,2-cyclohexanediol, 1,3-cyclohexanediol, 1,4-cyclohexanediol, 1,2-cyclohexanedimethanol (1,2-dimethylolcyclohexane), 1,3-cyclohexanedimethanol (1,3-dimethyloicyclohexane), 1,4-cyclohexanedimethanol (1,4-dimethylolcyclohexane) or 2,2,4,4-tetramethyl-1,3-cyclobutanediol.

Examples of suitable aromatic diols are 1,4-dihydroxybenzene, 1,3-dihydroxybenzene, 1,2-dihydroxybenzene, bisphenol A (2,2-bis(4-hydroxyphenyl)propane), 1,3-dihydroxynaphthalene, 1,5-dihydroxynaphthalene or 1,7-dihydroxynaphthalene.

However, the diol compounds G used may also be polyetherdiols, for example diethylene glycol, triethylene glycol, polyethylene glycol (having ≧4 ethylene oxide units), propylene glycol, dipropylene glycol, tripropylene glycol, polypropylene glycol (having ≧4 propylene oxide units) and polytetrahydrofuran (poly THF), in particular diethylene glycol, triethylene glycol and polyethylene glycol (having ≧4 ethylene oxide units). The poly THF, polyethylene glycol or polypropylene glycol which find use are compounds whose number-average molecular weight (Mₙ) is generally in the range from 200 to 10 000 g/mol, preferably from 600 to 5000 g/mol.

It will be appreciated that mixtures of the above diol compounds G may also be used.

The optional hydroxycarboxylic acid compounds H used can be the free hydroxycarboxylic acids, the C₁-C₅-alkyl esters thereof and/or the lactones thereof. Examples include glycolic acid, D-, L-, D,L-lactic acid, 6-hydroxyhexanoic acid (6-hydroxycaproic acid), 3-hydroxybutyric acid, 3-hydroxyvaleric acid, 3-hydroxycaproic acid, p-hydroxybenzoic acid, the cyclic derivatives thereof such as glycolide (1,4-dioxane-2,5-dione), D-, L-, D,L-dilactide (3,6-dimethyl-1,4-dioxane-2,5-dione), ε-caprolactone, β-butyrolactone, γ-butyrolactone, dodecanolide (oxacyclotridecan-2-one), undecanolide (oxacyclododecan-2-one) or pentadecanolide (oxacyclohexadecan-2-one). It will be appreciated that it is also possible to use mixtures of different hydroxycarboxylic acid compounds H.

The optional amino alcohol compounds I used may in principle be any such compounds, but preferably C₂-C₁₂-aliphatic, C₅-C₁₀-cycloaliphatic or aromatic organic compounds which have only one hydroxyl group and a secondary or primary, but preferably a primary, amino group. Examples include 2-aminoethanol, 3-aminopropanol, 4-aminobutanol, 5-aminopentanol, 6-aminohexanol, 2-aminocyclopentanol, 3-aminocyclopentanol, 2-aminocyclohexanol, 3-aminocyclohexanol, 4-aminocyclohexanol and 4-aminomethylcyclohexanemethanol (1-methylol-4-aminomethylcyclohexane). It will be appreciated that it is also possible to use mixtures of the above amino alcohol compounds I.

Further components which may be used optionally in the process according to the invention include organic compounds K which have at least 3 hydroxyl, primary or secondary amino and/or carboxyl groups per molecule. Examples include tartaric acid, citric acid, malic acid, trimethylolpropane, trimethylolethane, pentaerythritol, polyethertriols, glycerol, sugar (for example glucose, mannose, fructose, galactose, glucosamine, sucrose, lactose, trehalose, maltose, cellobiose, gentianose, kestose, maltotriose, raffinose, trimesic acid (1,3,5-benzenetricarboxylic acid and the esters or anhydrides thereof), trimellitic acid (1,2,4-benzenetricarboxylic acid and the esters or anhydrides thereof), pyromellitic acid (1,2,4,5-benzenetetracarboxylic acid and the esters or anhydrides thereof), 4-hydroxyisophthalic acid, diethylenetriamine, dipropylenetriamine, bishexamethylenetriamine, N,N′-bis(3-aminopropyl)ethylenediamine, diethanolamine or triethanolamine. The aforementioned compounds K are capable by virtue of their at least 3 hydroxyl, primary or secondary amino and/or carboxyl groups per molecule of being incorporated simultaneously into at least 2 polyamide chains, which is why compound K has a branching or crosslinking action in the polyamide formation. The higher the content of compounds K, and the more amino, hydroxyl and/or carboxyl groups are present per molecule, the higher the degree of branching/crosslinking in the polyamide formation. It will be appreciated that it is also possible in this context to use mixtures of compounds K.

According to the invention, it is also possible to use mixtures of diamine compound E, dicarboxylic acid compound F, diol compound G, hydroxycarboxylic acid compound H, amino alcohol compound I and/or organic compound K which has at least 3 hydroxyl, primary or secondary amino and/or carboxyl groups per molecule.

When, in accordance with the invention, at least one of the aforementioned compounds E to K is also used in addition to the aminocarboxylic acid compound A, it has to be ensured that the amounts of compounds A and E, F, G, H, I and/or K are selected such that the ratio of equivalents of the carboxyl groups and/or derivatives thereof (from the individual compounds A, F, H and K) to the sum of amino and/or hydroxyl groups and/or derivatives thereof (from the individual compounds A, E, G, H, I and K) is from 0.5 to 1.5, generally from 0.8 to 1.3, frequently from 0.9 to 1.1 and often from 0.95 to 1.05. It is particularly favorable when the ratio of equivalents is 1, i.e. just as many amino and/or hydroxyl groups are present as carboxyl groups or groups derived therefrom. For a better understanding, it should be pointed out that the aminocarboxylic acid compound A contains one equivalent of carboxyl groups, the dicarboxylic acid compound F (free acid, ester, halide or anhydride) contains 2 equivalents of carboxyl groups, the hydroxycarboxylic acid compound H contains one equivalent of carboxyl groups and the organic compound K has as many equivalents of carboxyl groups as it contains carboxyl groups per molecule. Correspondingly, the aminocarboxylic acid compound A contains one equivalent of amino groups, the diamine compound E contains 2 equivalents of amino groups, the diol compound G contains 2 equivalents of hydroxyl groups, the hydroxycarboxylic acid compounds H contain one hydroxyl group equivalent, the amino alcohol compound I contains one amino group and one hydroxyl group equivalent, and the organic compound K contains as many equivalents of hydroxyl and amino groups as it contains hydroxyl and amino groups in the molecule.

It is self-evident for the process according to the invention that the hydrolases B are selected so as to be compatible especially with the aminocarboxylic acid compound A, diamine compound E, dicarboxylic acid compound F, diol compound G, hydroxycarboxylic acid compound H, amino alcohol compound I and/or organic compound K which contains at least 3 hydroxyl, primary or secondary amino and/or carboxyl groups per molecule used, and the dispersant C and the solvent D, and not to be deactivated by them. Which compounds A and C to K can be used for a certain hydrolase is known or can be determined by those skilled in the art in simple preliminary experiments.

When one of the aforementioned compounds E, F, G, H, I and/or K is used in addition to the aminocarboxylic acid compound A, the process according to the invention proceeds in such a way that at least a portion of aminocarboxylic acid compound A, compound E, F, G, H, I and/or K, dispersant C and if appropriate solvent D is first introduced into a portion or even the entirety of the water, then a disperse phase which comprises the aminocarboxylic acid compound A and the compound E, F, G, H, I and/or K and/or if appropriate the solvent D and has an average droplet diameter of ≦1000 nm (miniemulsion) is obtained by means of suitable measures, and then the entirety of the hydrolase B and any remaining amounts of water, aminocarboxylic acid compound A, compound E, F, G, H, I and/or K, dispersant C and if appropriate solvent D are added at reaction temperature to the aqueous medium. Frequently, ≧50% by weight, ≧60% by weight, ≧70% by weight, ≧80% by weight, ≧90% by weight or even the entireties of aminocarboxylic acid compound A, compound E, F, G, H, I and/or K, dispersant C and if appropriate solvent D are introduced into ≧50% by weight, ≧60% by weight, ≧70% by weight, ≧80% by weight, ≧90% by weight or even the entirety of the water, then the disperse phase having an average droplet diameter of ≦1000 nm is obtained, and then the entirety of the hydrolase B and any remaining amounts of water, aminocarboxylic acid compound A, compound E, F, G, H, I and/or K, dispersant C and if appropriate solvent D are added at reaction temperature to the aqueous medium. The hydrolase B and any remaining amounts of water, aminocarboxylic acid compound A, compound E, F, G, H, I and/or K, dispersant C and if appropriate solvent D may be added to the aqueous reaction medium discontinuously in one portion, discontinuously in several portions or continuously with uniform or varying mass flow rates.

The process according to the invention proceeds generally at a reaction temperature of from 20 to 90° C., often from 35 to 60° C. and frequently from 45 to 55° C., at a pressure (absolute values) of generally from 0.8 to 10 bar, preferably from 0.9 to 2 bar and in particular at 1 bar (atmospheric pressure).

It is further advantageous when the aqueous reaction medium has a pH at room temperature (20 to 25° C.) of ≧2 and ≦11, frequently ≧3 and ≦9 and often ≧6 and ≦8. In particular, a pH (range) is established in the aqueous reaction medium at which the hydrolase B has optimal action. Which pH (range) this is is known or can be determined by those skilled in the art in a few preliminary experiments. The appropriate measures for adjusting the pH, i.e. addition of appropriate amounts of acid, for example sulfuric acid, bases, for example aqueous solutions of alkali metal hydroxides, in particular sodium hydroxide or potassium hydroxide, or buffer substances, for example potassium dihydrogenphosphate/disodium hydrogenphosphate, acetic acid/sodium acetate, ammonium hydroxide/ammonium chloride, potassium dihydrogenphosphate/sodium hydroxide, borax/hydrochloric acid, borax/sodium hydroxide or tris(hydroxymethyl)-aminomethane/hydrochloric acid, are familiar to those skilled in the art.

For the process according to the invention, the water used is typically clear and frequently has drinking water quality. However, the water used for the process according to the invention is advantageously deionized water. The amount of water is selected in such a way that the aqueous polyamide dispersion obtainable in accordance with the invention has a water content of ≧30% by weight, frequently ≧50 and ≦99% by weight or ≧65 and ≦95% by weight and often ≧70 and ≦90% by weight, based in each case on the aqueous polyamide dispersion, corresponding to a polyamide solids content of ≦70% by weight, frequently ≧1 and ≦50% by weight or ≧5 and ≦35% by weight and often ≧10 and ≦30% by weight. It should also be mentioned here that the process according to the invention is carried out advantageously under oxygen-free inert gas atmosphere, for example under nitrogen or argon atmosphere.

Advantageously in accordance with the invention, an assistant (deactivator) which is capable of deactivating the hydrolase B used in accordance with the invention (i.e. of destroying or of inhibiting the catalytic action of the hydrolase B) is added to the aqueous polyamide dispersion after or at the end of the enzymatically catalyzed polymerization reaction. The deactivators used may be any compounds which are capable of deactivating the particular hydrolase B. The deactivators used may frequently in particular be complexes, for example nitrilotriacetic acid or ethylenediaminetetraacetic acid or alkali metal salts thereof, or anionic emulsifiers, for example sodium dodecylsulfate. Their amount is typically just enough to deactivate the particular hydrolase B. It is frequently also possible to deactivate the hydrolases B used by heating the aqueous polyamide dispersion to temperatures of ≧95° C. or ≧100° C., in the course of which inert gas is injected under pressure to suppress a boiling reaction. It will be appreciated that it is also possible to deactivate certain hydrolases B by changing the pH of the aqueous polyamide dispersion.

The polyamides obtainable by the process according to the invention may have glass transition temperatures of from −70 to +200° C. Depending on the intended use, polyamides are frequently required whose glass transition temperatures lie within particular ranges. Suitable selection of the components A and E to K used in the process according to the invention makes it possible for those skilled in the art to selectively prepare polyamides whose glass transition temperatures lie within the desired range. When, for example, the polyamides obtainable by the process according to the invention are to be used as pressure-sensitive adhesives, the composition of the compounds used is selected in such a way that the polyamides obtained have glass transition temperatures of ≦0° C., frequently ≦−5° C. and often ≦−10° C. On the other hand, when the polyamides are to find use as binders in coating formulations, for example, the composition of the compounds used is selected in such a way that the polyamides obtained have glass transition temperatures of from −40 to +150° C., frequently from 0 to +100° C. and often from +20 to +80° C. Corresponding requirements also apply to polyamides which are to be used in other fields of application.

The glass transition temperature T_{g} means the limiting value of the glass transition temperature, the glass transition temperature approaching the limiting value with increasing molecular weight according to G. Kanig (Kolloid-Zeitschrift & Zeitschrift fur Polymere, vol. 190, page 1, equation 1). The glass transition temperature is determined by the DSC process (Differential Scanning Calorimetry, 20 K/min, midpoint measurement, DIN 53 765).

The polyamide particles of the aqueous polyamide dispersions obtainable by the process according to the invention have average particle diameters which are generally between 10 and 1000 nm, frequently between 50 and 700 nm and often between 100 and 500 nm [the values reported are the cumulant z-average values, determined by quasielastic light scattering (ISO standard 13 321)].

The polyamides obtainable by the process according to the invention generally have a weight-average molecular weight in the range from≧2000 to≦1 000 000 g/mol, often from≧3000 to≦500 000 g/mol and frequently from≧5000 to≦300 000 g/mol. The weight-average molecular weights are determined by means of gel permeation chromatography based on DIN 55672-1.

The aqueous polyamide dispersions obtainable by the process according to the invention are suitable advantageously as components in adhesives, sealants, polymer renders, papercoating slips, printing inks, cosmetics formulations and paints, for finishing leather and textiles, for fiber binding and for modification of mineral binders or asphalt.

It is also significant that the aqueous polyamide dispersions obtainable in accordance with the invention can be converted to the corresponding polyamide powder by drying. Corresponding drying methods, for example freeze-drying or spray-drying, are known to those skilled in the art.

The polyamide powders obtainable in accordance with the invention can be used advantageously as a pigment, filler in polymer formulations, as a component in adhesives, sealants, polymer renders, papercoating slips, printing inks, cosmetics formulations, powder coatings and paints, for finishing leather and textiles, for fiber binding and for modification of mineral binders or asphalt.

The process according to the invention opens up a simple and inexpensive route to aqueous primary polyamide dispersions whose polyamide generally has distinctly higher molecular weights than the corresponding aqueous secondary polyamide dispersions.

The nonrestrictive examples below are intended to illustrate the invention.

### EXAMPLES

The weight-average molecular weight data of the polyamides obtainable in accordance with the invention are based on determinations by means of gel permeation chromatography (based on DIN 55672-1) under the following conditions:

| | |
|---|---|
| Precolumn: | PL HFIP gel (internal diameter: 7.5 mm, length: 5 cm) |
| Separating | PL HFIP gel (internal diameter: 7.5 mm, length: |
| column: | 30 cm; from Polymer Laboratories GmbH) |
| Eluent: | Hexafluoroisopropanol containing 0.05% by weight of |
| | potassium trifluoroacetate |
| Temperature: | 40° C. |
| Detection: | Differential refractometer, G1362A 1100 series (from |
| | Agilent Technologies Inc.) |
| | UV detector, GAT LCD 503 (from Gamma |
| | Analysentechnik GmbH) |
| Flow rate: | 0.5 ml/min., HPLC pump 420 (from Kontron |
| | Instruments Ltd.) |
| Injection: | 20 μl |
| Evaluation: | WinGPC Scientific V6.20 software (from Polymer Standard |
| | Service GmbH) |
| Calibration: | by means of polymethyl methacrylate (PMMA) Ready-Cal |
| | kits (from Polymer Standard Service GmbH) |

Precolumn: PL HFIP gel (internal diameter: 7.5 mm, length: 5 cm)
Separating column: PL HFIP gel (internal diameter: 7.5 mm, length: 30 cm; from Polymer Laboratories GmbH)
Eluent: Hexafluoroisopropanol containing 0.05% by weight of potassium trifluoroacetate
Temperature: 40° C.
Detection: Differential refractometer, G1362A 1100 series (from Agilent Technologies Inc.)
   UV detector, GAT LCD 503 (from Gamma Analysentechnik GmbH)
Flow rate: 0.5 ml/min., HPLC pump 420 (from Kontron Instruments Ltd.)
Injection: 20 μl
Evaluation: WinGPC Scientific V6.20 software (from Polymer Standard Service GmbH)
Calibration: by means of polymethyl methacrylate (PMMA) Ready-Cal kits (from Polymer Standard Service GmbH)

The solids contents were generally determined by drying a defined amount of the aqueous polyamide dispersion (approx. 5 g) at 180° C. in a drying cabinet to constant weight. In each case, two separate measurements were carried out. The value reported in the particular examples is the average of the two measurement results.

The average particle diameter of the polyamide particles was generally determined by dynamic light scattering on a from 0.005 to 0.01 percent by weight aqueous dispersion at 23° C. by means of an Autosizer IIC from Malvern Instruments, England. The value reported is the average diameter of the cumulant evaluation (cumulant z-average) of the autocorrelation function measured (ISO standard 13321).

The glass transition temperature and the melting point were determined generally according to DIN 53765 by means of a DSC820 instrument, TA8000 series from Mettler-Toledo Intl. Inc.

### Example 1

Under a nitrogen atmosphere, 4.8 g (43 mmol) of ε-caprolactam (Sigma-Aldrich Inc.) were added at room temperature with stirring (20 to 25° C.) to a homogeneous solution of 0.24 g of Lutensol® AT 50 (nonionic emulsifier, commercial product from BASF AG) and 23.8 g of deionized water. Afterward, 0.5 g of toluene was added to the resulting homogeneous solution. Subsequently, the resulting heterogeneous mixture was stirred with a magnetic stirrer at 60 revolutions per minute (rpm) for 10 minutes, then transferred into an 80 ml conical-shoulder vessel, likewise under nitrogen, and stirred at 20 500 rpm by means of an Ultra-Turrax T25 unit (from Janke & Kunkel GmbH & Co. KG) for 30 seconds. Afterward, the resulting liquid heterogeneous mixture was converted to droplets having an average droplet diameter of ≦1000 nm (miniemulsion) by subjecting it to an ultrasound treatment by means of an ultrasound probe (70 W; UW 2070 unit from Bandelin electronic GmbH & Co. KG) for 3 minutes. A homogeneous enzyme mixture prepared from 0.24 g of lipase from Candida antarctica type B (commercial product from Fluka AG), 0.14 of Lutensol® AT 50 and 14.2 g of deionized water were then added in one portion under a nitrogen atmosphere to the thus prepared miniemulsion, then the resulting mixture was heated to 60° C. with stirring and the mixture was stirred at this temperature for 20 hours under a nitrogen atmosphere. The resulting aqueous polyamide dispersion was then cooled to room temperature, 0.06 g of sodium docecylsulfate was added with stirring for enzyme deactivation and the aqueous polyamide dispersion was stirred for a further 30 minutes.

Approx. 43 g of an aqueous dispersion of Polyamide with 6-aminocaproic acid units (=polycaprolactam, nylon-6) having a solids content of approx. 9% by weight, based on the aqueous dispersion, were obtained. The average particle size was determined to be approx. 220 nm.

To determine the weight-average molecular weight, the glass transition temperature and the melting point of the resulting polyamide, 10 g of the resulting aqueous polyamide dispersion were subjected to a centrifugation (3000 rpm) for 10 minutes, in the course of which the polyamide particles separated as a sediment. The supernatant clear aqueous solution was decanted off and the polyamide particles were slurried by means of 10 g of deionized water and stirred for 10 minutes. Subsequently, the sedimentation by means of centrifuge, decantation of the supernatant clear solution, etc. were repeated. Overall, the resulting polyamide particles were treated by the above procedure three times with 10 g each time of deionized water and then three times with 10 g each time of tetrahydrofuran. The remaining polymeric residue was subsequently dried at 50° C./1 mbar (absolute) for 5 hours. The thus obtained polyamide (approx. 0.25 g) had a weight-average molecular weight Mw of 212 000 g/mol and a number-average molecular weight Mn of 47 000 g/mol. The melting point was determined to be approx. 200° C.

### Example 2

2.9 g (12 mmol) of pentadecanolide (98% by weight, Sigma-Aldrich Inc.) and 0.3 g of hexadecane were mixed homogeneously at 45° C. under a nitrogen atmosphere and this mixture was added with stirring at 50° C. to a homogeneous solution of 3.2 g (28 mmol) of ε-caprolactam, 0.3 g of Lutensol® AT 50 and 29.7 g of deionized water. Subsequently, the resulting heterogeneous mixture was stirred at 60 revolutions per minute (rpm) with a magnetic stirrer at 50° C. for 10 minutes, then transferred into an 80 ml conical-shoulder vessel, likewise under nitrogen, and stirred at 20 500 rpm by means of an Ultra-Turrax T25 unit (from Janke & Kunkel GmbH & Co. KG) for 30 seconds. Afterward, the resulting liquid heterogeneous mixture was converted to droplets having an average droplet diameter of ≦1000 nm (miniemulsion) by subjecting it to an ultrasound treatment by means of an ultrasound probe (70 W; UW 2070 unit from Bandelin electronic GmbH & Co. KG) for 3 minutes. A homogeneous enzyme mixture prepared from 0.18 g of lipase from Candida antarctica type B, 0.18 of Lutensol® AT 50 and 18 g of deionized water was added in one portion under nitrogen to the thus prepared miniemulsion, then the resulting mixture was heated to 55° C. with stirring and the mixture was stirred at this temperature for 20 hours under a nitrogen atmosphere. Subsequently, the resulting aqueous polyamide dispersion was cooled to room temperature, 0.06 g of sodium docecylsulfate was added with stirring for enzyme deactivation and the aqueous polyamide dispersion was stirred for a further 30 minutes.

Approx. 53 g of an aqueous dispersion of polyamide having —NH—(CH₂)₅—C(═O)— and —O—(CH₂)₁₄—C(═O)— units and a solids content of approx. 11% by weight, based on the aqueous dispersion, were obtained. The average particle size was determined to be approx. 150 nm.

To determine the weight-average molecular weight, the glass transition temperature and the melting point of the resulting polyamide, 10 g of the resulting aqueous polyamide dispersion were subjected to a centrifugation (3000 rpm) for 10 minutes, in the course of which the polyamide particles separated as a sediment. The supernatant clear aqueous solution was decanted off and the polyamide particles were slurried by means of 10 g of deionized water and stirred for 10 minutes. Subsequently, the sedimentation by means of centrifuge, decantation of the supernatant clear solution, etc. were repeated. Overall, the resulting polyamide particles were treated by the above procedure three times with 10 g each time of deionized water and then three times with 10 g each time of tetrahydrofuran. The remaining polymeric residue was subsequently dried at 50° C./1 mbar (absolute) for 5 hours. The thus obtained polyamide (approx. 1 g) had a weight-average molecular weight Mw of 16 600 g/mol and melting points at 94° C. and approx. 210° C.

1. A process for preparing an aqueous polyamide dispersion, which comprises reacting, in an aqueous medium,
a) an aminocarboxylic acid compound A
in the presence of
b) a hydrolase B and
c) a dispersant C, and
d) optionally, a low water solubility organic solvent D.

2. The process according to claim 1, wherein at least one portion of the aminocarboxylic acid compound A and/or, optionally, of the solvent D is present in the aqueous medium as a disperse phase having an average droplet diameter of ≦1000 nm.

3. The process according to claim 2, wherein at least a portion of aminocarboxylic acid compound A, dispersant C and, optionally, solvent D is first introduced into a portion or the entirety of water, then a disperse phase which comprises the aminocarboxylic acid compound A and/or, optionally, the solvent D and has an average droplet diameter of ≦1000 nm is obtained, and then the entirety of the hydrolase B and any remaining amounts of water, aminocarboxylic acid compound A, dispersant C and solvent D are added at reaction temperature to the aqueous medium.

4. The process according to claim 1, wherein the amount of the low water solubility organic solvent D is from 0.1 to 40% by weight, based on the total amount of water used.

5. The process according to claim 1, wherein the polymerization reaction is effected by using a diamine compound E, a dicarboxylic acid compound F, a diol compound G, a hydroxycarboxylic acid compound H, an amino alcohol compound I and/or an organic compound K which contains at least 3 hydroxyl, primary or secondary amino and/or carboxyl groups per molecule in addition to the aminocarboxylic acid compound A.

6. The process according to claim 5, wherein the sum of the total amounts of individual compounds E, F, G, H, I and/or K is ≦100% by weight, based on the total amount of aminocarboxylic acid compound A.

7. The process according to claim 5, wherein the amounts of the compounds A and E, F, G, H, I and/or K are selected in order that the ratio of equivalents of the carboxyl groups and/or derivatives thereof (from the individual compounds A, F, H and K) to the sum of amino and/or hydroxyl groups and/or derivatives thereof (from the individual compounds A, E, G, H, I and K) is from 0.5 to 1.5.

8. The process according to claim 1, wherein the hydrolase B is a lipase and/or a carboxylesterase.

9. The process according to claim 1, wherein the dispersant C is a nonionic emulsifier.

10. The process according to claim 1, wherein the solvent D and amount thereof are selected in order that≦50% by weight of solvent D is dissolved in the aqueous medium under reaction conditions.

11. The process according to claim 1, wherein the aqueous medium has a pH of ≧3 and ≦9.

12. The process according to claim 1, wherein the aminocarboxylic acid compound A used is a lactam.

13. The process according to claim 1, wherein the aminocarboxylic acid compound A is ε-caprolactam and/or ω-laurolactam.

14. The process according to claim 1, wherein the aminocarboxylic acid compound A and, optionally, the compounds E to K are selected in order that the resulting polyamide has a glass transition temperature of from −50 to +200° C.

15. An aqueous polyamide dispersion obtainable by the process according to claim 1.

16. A method of using the aqueous polyamide dispersion according to claim 15 as a component in adhesives, sealants, polymer renders, papercoating slips, printing inks, cosmetics formulations and paints, for finishing leather and textiles, for fiber binding and for modification of mineral binders or asphalt.

17. A method for the preparation of a polyamide powder by drying an aqueous polyamide dispersion according to claim 15.

18. A method of using a polyamide powder prepared according to claim 17 as a pigment, as a filler in polymer formulations, as a component in adhesives, sealants, polymer renders, papercoating slips, printing inks, cosmetics formulations, powder coatings and paints, for finishing leather and textiles, for fiberbinding, and for modifying mineral binders or asphalt.
